(19) United States
(12) Patent Application Publication
(10) Pub. No.: US 2002/0077848 A1
(43) Pub. Date: Jun. 20, 2002

(54) Method for creation of a customized book

(76) Inventor: Bruce M. Campbell, Minneapolis, MN (US)

Correspondence Address: Scott A. Marks, DORSEY & WHITNEY LLP, Suite 1500, 50 South Sixth Street, Minneapolis, MN, 55402-1498, US

(21) Appl. No.: 10/025,036

(22) Filed: Dec. 19, 2001

Related U.S. Application Data
(60) Provisional application No. 60/256,770, filed on Dec. 19, 2000.

(51) Int. Cl. G06F 17/60

(52) U.S. Cl. 705/1

(57) ABSTRACT

The invention includes a method of creating a customized product. The invention includes presenting a customizable template to a customer who then, as an customer, provides the names of peoples, pets, and places that the reader or customer is familiar with for incorporation into the book. The customer also presents to the service provider copies of images that are incorporated into the story for further customization. Once the names and images and other customizable story variations are selected by the customer, the book is then published and sent. The customized product may include a book, game, toy, business training aid, or other products, such promotional material.

### RELATED APPLICATIONS

This application claims the benefit of Provisional Application Serial No. 60/256,770, filed Dec. 19, 2000.

### FIELD

The present invention relates to customizable products. In particular, the present invention is a method for the creation of customized products wherein customized information relates to the one or more individuals for whom the product is intended.

### BACKGROUND

Improvements of the digital age, including digital cameras, digital audio and visual recorders, and the Internet have provided the technology for making customizable products. Calendars, cards, and other products have been previously customized in simple ways to produce products. The pictures, sounds, and stories that come with these new books and games, however, only allow for limited customization of a few names and include stock pictures, sounds, and stories printed therein by the manufacturer. The customized calendars only allow for placement of pictures at pre-determined locations.

A need therefore exists for a method of creating a customized product that includes pictures, names, sounds, etc. that are specific to the customer. In addition, a need exists for a cost effective method of incorporating this information into a custom produced product.

### SUMMARY

The present invention includes a method of creating a customized product by using a template that includes blank spaces for the insertion therein of text and other images. A service provider provides the template and queries a customer for a set of customized information, including, but not limited to, images, pictures, drawings, paintings, names, places, people, phrases, and otherwise. The service provider receives the customized information and inserts the information into the indicated places in the product, whether the product is a book, game, toy, business tool, promotional material, or some other customizable product. The product is then produced and sent to the customer.

A method of producing a customized book, the method comprising providing a book wherein the book has blank places in the text for insertion therein of customized text and blank images for insertion therein of customized images, receiving text from a customer, wherein the text is designated for insertion into the book at the blank places in the text, receiving images from a customer, wherein the images designated for insertion into the book at specified blank images, integrating the text and the images into the stock book, and printing the customized book.

In another embodiment, the method for the production of a customized product includes providing a customer with a list of customizable products, receiving from the customer a selection of a product for customization, querying the customer for a set of custom information in response to the customer's selection of the customizable product, receiving from the customer the set of custom information, and inputting the set of custom information into the desired product.

In still a further embodiment, the method for customizing a book includes querying a customer for a set of custom information, receiving from the customer the set of custom information, querying the customer for at least one image for inclusion in the customized book, receiving from the customer at least one image, integrating the set of custom information and the at least one image into a layout for the customized book, and printing the customized book.

### BRIEF DESCRIPTION OF THE DRAWINGS

FIG. 1 represents a flow chart of the present invention.

FIG. 2 is a representative customizable page from an alphabet book.

FIG. 3 is a customized page from the alphabet book.

FIG. 4 is another customized page from the alphabet book.

FIG. 5 is a stock page from the alphabet book.

### DETAILED DESCRIPTION

The present invention is a method of producing a customized product, such as a book, game, toy, or other product. The present embodiment is described in terms of producing a customized children's alphabet book 10. The book 10 can be customized with pictures and names of parents, grandparents, friends, pets, and other familiar places and people with whom the child interacts. The customization will help improve both the child's interest in the product and the child's memory. The stronger link provided by the familiar material may help spark the child's interest in the book 10 and may also spark the child's interest in learning.

The present invention will be further described in terms of a “customer 12.” The customer 12 is a person who orders and pays for the customized book 10. The customer 12 provides customized information for insertion into the book 10, or, in an alternative embodiment, the customer 12 purchases the book 10 and thereafter gets another person to enter the customized information 14. In the case of the customer 12 only ordering the customized book 10, the text, names, photographs, etc., are provided by a separate individual who may be referred to as an “information provider 13.” For example, in one instance, the customer 12 may be a grandparent of the intended recipient, and the information provider 13 may be a parent. As used herein, the term customer 12 refers to a person who orders and provides the customized information for the customized book 10, but many of these steps could be done by the information provider 13 rather than by the customer 12.

As used in the present description, the term “customized information 14” refers to names, text, photographs, music, audio clips, sound effects, and other types of images such as pictures, paintings, drawings created by the child, or otherwise. In the present embodiment, the pictures are taken utilizing a color digital camera and are submitted by uploading to a Website or by e-mail. The present description may also utilize the term “information 14” to refer to the customized information 14.

The present description includes a “service provider 16.” The service provider 16 provides the customizable book 10, accessed through the below described Web page, through which the customer 12 to submit the customized information 14 for the book 10. The service provider 16 provides the customer 12 with the ability to forward the customized information 14 through the use of the Web page, an e-mail address, or a form that is filled out and mailed. In further embodiments, the service provider 16 may collect the customized information at a mall kiosk or may provide the customizable book 10 and collect the customized information 14 through a related partnership store, such as a photo shop or an electronics store. Such a service provider 16 may also have the ability to receive electronic pictures (through the Internet or on disk), receive regularly printed pictures, or may have the necessary electronic scanners to instantly convert normal photographs to electronic images. The service provider 16 manipulates the software and other tools necessary to create the book 10. The service provider 16 does not necessarily physically bind the book 10, but coordinates this service to result in the finished book 10.

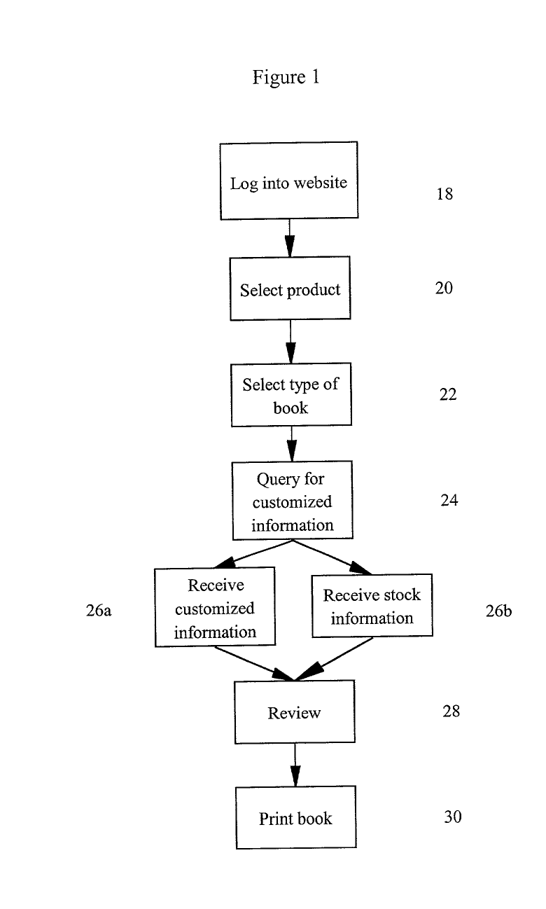

As illustrated in FIG. 1, the customer 12, utilizing a personal computer or other device for accessing the Internet, accesses (18) a Web page (not illustrated) provided by the service provider 16. The Web page has a welcome screen that informs the customer 12 of the various services provided. Wishing to order a customized book 10, the customer 12 selects (20) the appropriate icon for a book 10. The book 10 presented on the Web is actually a template for a book, with the customized information 14 completing the template such that it forms the customized book 10. For convenience sake, however, the book 10 template will be referred to herein as book 10, alphabet book 10, or customizable book 10.

After selection of the appropriate icon on the welcome page, the customer 12 is then provided with a second Web page (not illustrated). The second Web page illustrates to the customer 12 the various options that are available for different customized books 10. A number of different books 10 may be provided so the information provider 13 can select a desired story or learning experience. The customer 12 selects (22) the icon representing an alphabet book 10. Once the type of book 10 has been selected by clicking on the appropriate icon, the Web page begins to query (24) the customer 12 for the customized information 14 required to complete the alphabet book 10.

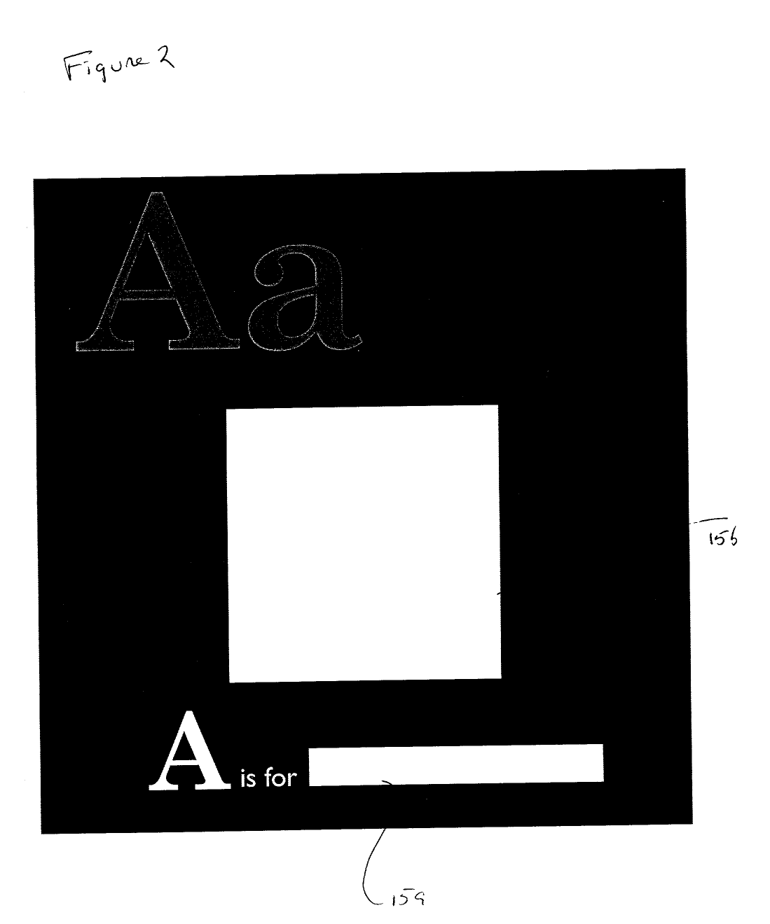

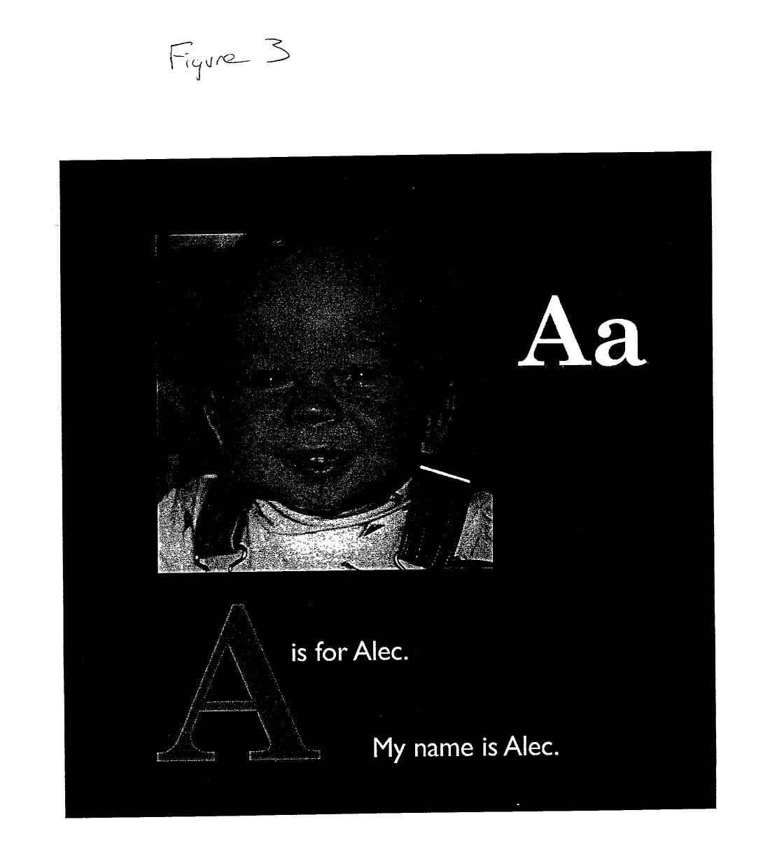

As illustrated in FIG. 2, the queries (24) may be presented by showing the page for the book 10 where the customized information 14 will be inserted. A text blank 15a and an image blank 15b represent to the customer 12 the erquired 14 and enables the customer 12 to enter appropriate customized information 14. The customer 12 enters the information 14 into the text blank 15a and downloads an image for the image blank 15b. Alternatively, all of the questions may be laid out in a one or two page format, wherein multiple pieces of information are provided by the customer 12 on each page. The images for the image blank 15b can be described to the customer 12 who then uploads images for placement in indicated image blanks 15b. FIG. 3 illustrates the page in FIG. 2 after the customized information 14 has been entered in the text blanks 15a and the image blanks 15b.

As illustrated in FIG. 1 each image and letter phrase is customizable, and is therefore blank, unless the customer 12 provides information to be entered. In alternative embodiments, the alphabet book 10 may be filled in with stock text and images; the customer 12 then only changes that information 14 that the customer 12 wishes to change. This latter method of customization requires less input from the customer 12.

The customer 12, depending on the nature of the book 10 selected, provides desired images of pets, houses, cars, city scenes, parents, friends, or paintings, drawings and other images, created by the child or of some interest to the child. For alphabet book 10, it may be desirable that the selection of images correspond with the alphabet character for that page.

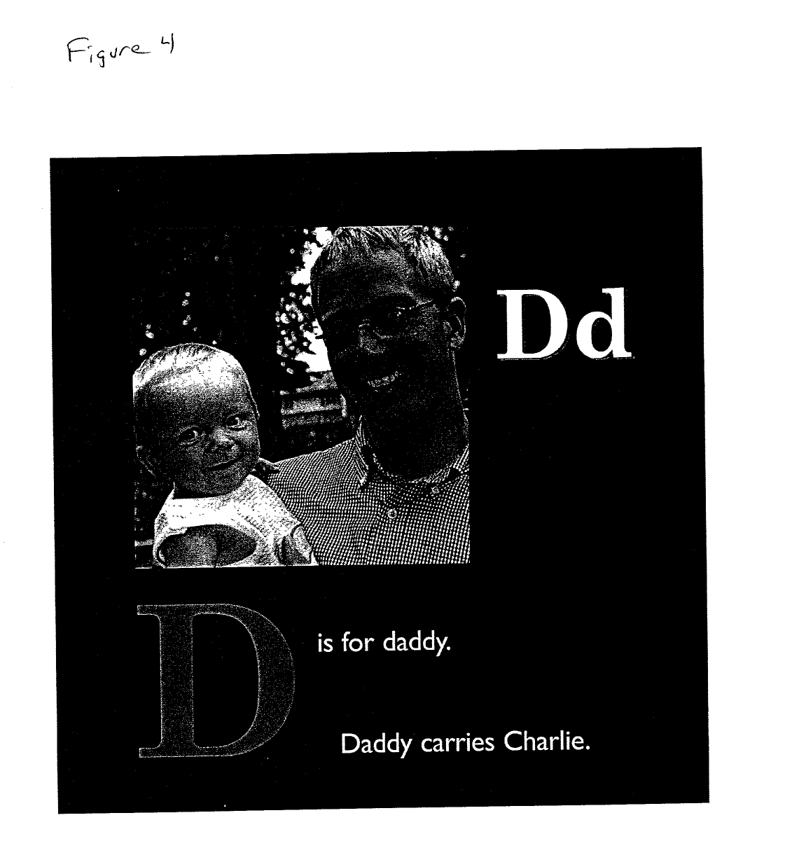

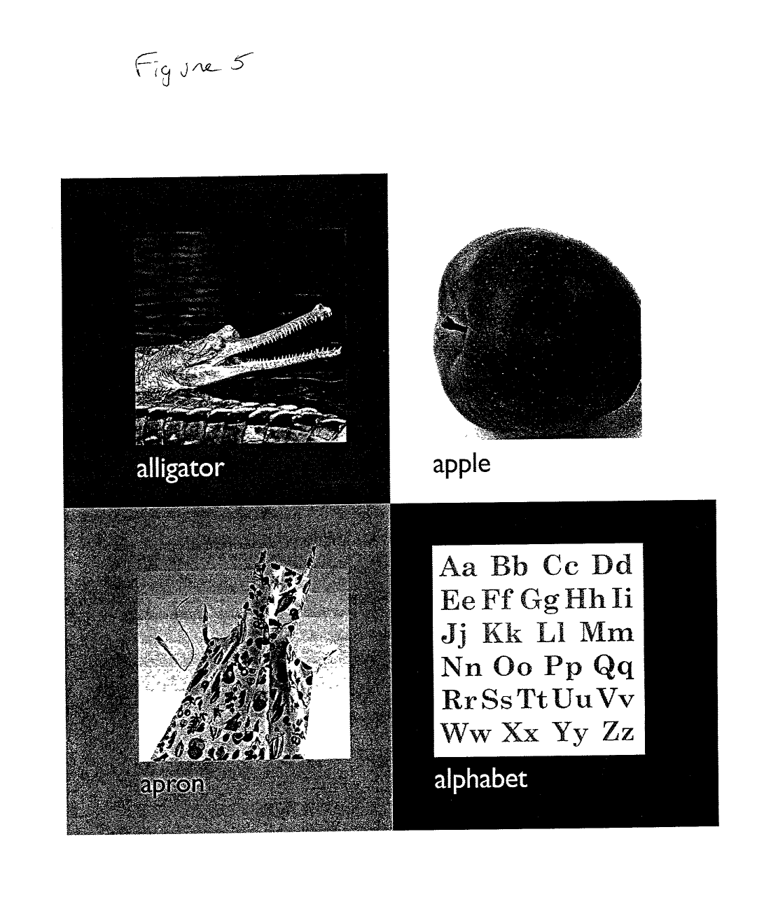

As illustrated in FIGS. 3-4, whole images, including the child and the child with a family member, are integrated into the book 10. As illustrated in FIG. 5, stock pages with images and words may also be included. The amount of stock information may be increased or decreased depending on the desires of the customer 10 and the specific product being customized.

In alternative embodiments, the image of the child is cropped or otherwise modified and manipulated in such a way that in the story the child is pictured as a fire fighter, an astronaut, a doctor, a super hero, or some other character that captures the child's imagination. In still further embodiments, an image of the child performing some activity, for example, riding a horse, may be utilized as customized information 14 to fill in the image blank 15b.

Referring again to FIG. 1, if the customer 12 either does not have suitable customized information 14, or does not wish to provide such information 14, the customer 12 selects (24) from a list of provided stock images and text to fill in the customizable blanks 15a and 15b. Such standard information may be places, names, or images that the customer 12 does not furnish. For example, if the customer 12 does not have a image suitable for insertion in the image blank 15b, the customer 12 may select from images provided by the service provider 16.

As may be appreciated by those skilled in the art, the quality of the image provided by the customer 12 will affect the quality of the final printed image in the book 10. Images that are taken with a high quality digital camera, or scanned using a high quality scanner, may result in a higher resolution of the images as they appear in the final book 10. If the customer 12 mails the images or provides the image at a brick and mortar location, the customer 12 can fill out the customized information 14 and provide the information directly. Providing the images by mail or directly to the brick and mortar store may allow for a better image to be included in the book 10 because of difficulties involved in true color high quality scanning and with uploading large files through e-mail or the Internet. In still further embodiments the information may be filled out directly at a brick and mortar store or filled out and provided via the mail.

Once the customer 12 provides all of the necessary information, or selects the desired stock information, the customer 12 may review (28) the information 14 to insure its accuracy. Once the customer 12 has verified the accuracy of the information 14, the customer 12 indicates to the service provider 16 that the information 14 is ready for incorporation into the customized book 10.

Once the information for the book 10 has been gathered, the book 10 is ready for organization into a printable/publishable form. The service provider 16 creates the book 10 through automated methods or by hand. The information 14 the customer 12 has provided in response to queries (24), such as the child's name, age, sex, and the child's favorite animal, pet, game, etc., may be entered into the correct text blanks 15a automatically. The images may be placed into the image blanks 15b automatically or manually. The layout is accomplished by utilizing standard desktop publishing software or other software produced by the service provider 16.

The service provider 16 may have personnel or software to perform the graphic arts steps of cropping the images and laying out the pages. In alternative embodiments, the graphic artwork may be outsourced to individuals on a freelance basis. In still other embodiments, the customer 12 can perform any necessary image cropping before the image is placed in the image blank 15b. Having the customer 12 perform the graphic arts steps in this manner may lower the cost of the final product.

Once the book 10 is organized and all of the desired customized information 14 is entered, the book 10 may be sent (30) for printing. The book 10 may be printed using a high quality color printer with commercial grade paper and thereafter bound as a hard cover book 10 in the same manner as other commercial children's books. Digital printing presses have the ability to print in a singular quantity and may be used to print the book 10 in a professional and economical manner. Selecting a higher quality paper and binding method may effect the price of the book 10 but does not effect the nature and scope of the present invention. After the book 10 is printed, it is sent to the intended recipient.

In one alternative embodiment, the customer 12 may change the positioning of the images in relation to the text, what type of font the book 10 uses, character size, etc. The customer 12 may be further provided with options as to what size paper the book 10 is printed on, whether the book 10 is hard-bound or soft bound, whether a personalized dedication page is included, and which image is used on the cover. The amount of customization that can be achieved when it comes to image cropping, placement, manipulation, modification etc., is almost limitless. Each selective customization, however, may increase the final cost of the selected book 10.

The customer 12 can exit the system at anytime, get a password, and come back to finish the book 10 later. Alternatively, the customer 12 may have the information provider 13 finish the book 10 or may let the child use his or her creative energies to customize the book 10. The customer 12 can provide a wide range of images and other options that the child, or the child with his or her parent, can choose. This embodiment both encourages the child creatively and creates a book 10 that the child may be interested in for a longer period of time.

The queries (24) for information may be replied to with as much or as little information 14 as the customer 12 wishes to provide. Information 14 may include the child's name, age, birth date, and where the child lives. Other information 14 may include the child's favorite color, food, game, animal, etc. The book 10 may also include characters popular with children so the child is introduced into a story with a favorite character from television, films, video games, or other books 10. Depending on the nature and sequence of the story, just about any type of information 14 may become relevant.

In one embodiment, the customer 12 may provide, through the Internet or through the mail, a recording of the customer 12 reading certain words or sections of the selected book 10. The audio clip is then digitally recorded onto a computer chip and incorporated into the book 10 so that when the child activates a switch, the child will hear a familiar voice making sound effects or reading sections of the book 10.

In still further embodiments, the customer 12 may modify the selected book 10 in a number of different ways. The customer 12 can choose the various plot twists he or she finds desirable to create a customized story.

The present invention method and system may be utilized to produce customized games, toys, teaching tools for children, business (such as training aids and tools or promotional literature), or other products, such as decks of playing card. The method for the customization of these other products is the same as, or similar to, the method as illustrated above.

The embodiments described herein are for illustrative purposes and are not meant to exclude any derivations or alternative methods that are within the conceptual context of the invention. It is contemplated that various deviations can be made to this embodiment without deviating from the scope of the present invention. Accordingly, it is intended that the scope of the present invention be dictated by the appended claims rather than by the foregoing description of this embodiment.

1. A method of producing a customized book, the method comprising:
providing a book wherein the book has text blanks for insertion therein of customized text and image blanks for insertion therein of customized images;
receiving text from a customer, wherein the text is designated for insertion into the book at the text blanks;
receiving an at least one image from a customer, wherein the at least one image designated for insertion into the book at the image blanks;
integrating the received text and images into the stock book; and
printing the customized book.

2. The method of claim 1 wherein receiving the text and images further comprises downloading the text and images from a Website.

3. The method of claim 1 wherein the text further comprises names.

4. The method of claim I wherein the at least one image is selected from the group consisting of photographs, drawings, computer images and stock images.

5. The method of claim 2 further comprising allowing the customer to select the location and placement of the at least one image in the book.

6. The method of claim 1 wherein the method further comprises receiving recorded sounds from the customer; and
inserting the recorded sounds into the customized book.

7. A method for the production of a customized product, the method comprising:
providing a customer with a list of customizable products;
receiving from the customer a selection of a product for customization;
querying the customer for a set of custom information in response to the customer's selection of the customizable product;
receiving from the customer the set of custom information; and
integrating the set of custom information into the desired product.

8. The method of claim 7 wherein the customized product is selected from the group consisting of a book, a toy, a game, and a business product.

9. The method of claim 7 wherein the set of custom information includes text.

10. The method of claim 7 wherein the set of custom information includes names.

11. The method of claim 7 wherein the set of custom information includes images.

12. The method of claim 7 wherein the set of custom information includes sounds.

13. The method of claim 7 wherein providing the customer with a list of customizable products further comprises providing a downloadable Web page accessible through the Internet.

14. The method of claim 7 wherein the querying the customer for a set of custom information further comprises providing a custom product with im age blanks and text blanks.

15. A method for customizing a book, the method comprising:
querying a customer for a set of custom information;
receiving from the customer the set of custom information;
querying the customer for at least one image for inclusion in the customized book;
receiving from the customer at least one image;
integrating the set of custom information and the at least one image into a layout for the customized book; and
printing the customized book.
